(19) United States
(12) Patent Application Publication
(10) Pub. No.: US 2007/0034831 A1
(43) Pub. Date: Feb. 15, 2007

(54) Synthesis of solid state dye laser by y-irradiation polymerization method

(76) Inventors: Attieh Al-Ghamdi, Riyadh (SA); Salem Al Deyab, Riyadh (SA); Abdullah Al Enizi, Riyadh (SA)

Correspondence Address: JEFFREY FURR, 253 N. MAIN STREET, JOHNSTOWN, OH, 43031, US

(21) Appl. No.: 11/161,613

(22) Filed: Aug. 9, 2005

(51) Int. Cl. C09K 11/02

(52) U.S. Cl. 252/301.35

(57) ABSTRACT

A Solid state dye laser (SSDL) mixture of rhodamine B (RB) dissolved in ethylene glycol (EG) and added in a 2-hydroxyethyl-methacrylate (HEMA) methyl-methacrylate (MMA) copolymerized by gamma irradiation polymerization method (GIPM).

This invention relates to a method and a device for synthesis of solid state dye lasers and in more particular by the use of a y-irradiation polymerization method.

### BACKGROUND

Dye lasers are known and used in many applications. Despite recent advances in diode laser technology, and the development of widely tunable solid state devices, e.g., Ti:sapphire and alexandrite lasers, it is likely that dye laser usage will continue.

Dye lasers offering both pulsed and continuous-wave operation are considered to be among the most successful laser sources currently in use due to their broad spectral range tuning from ultraviolet to the infrared and high quantum efficiency. They are simpler to produce and are cheap in comparison with other laser sources.

These lasers are used in fundamental physics, spectroscopic techniques, and such diverse areas as applications in industry, medicine, and military.

Two types of dye-doped active laser medium are mainly used, namely liquid and solid-state. At present, research on solid-state dye lasers is a very active field relative to conventional liquid dye laser because it has some operational advantages such as compactness, low cost fabrication techniques, suppression of flow fluctuations, suppression of evaporation of solvent.

### Prior Art

U.S. Pat. No. 6,870,868 by Kahen, et al. and issued on Mar. 22, 2005, is for an organic laser having improved linearity. It discloses an organic vertical cavity laser device that includes a substrate, a bottom dielectric stack reflective to light over a predetermined range of wavelengths and being disposed over the substrate, and an organic active region for producing laser light.

U.S. Pat. No. 6,539,041 by Scheps and issued on Mar. 25, 2003, is for a compact solid state dye laser. It discloses a novel apparatus for a compact solid state dye laser that includes a solid state laser gain element for generating laser pump energy, a passive Q-switch for generating high intensity bursts of laser pump energy, a frequency doubler for generating dye laser pump energy, and a solid state laser dye element for generating optical energy output.

U.S. Pat. No. 5,610,932 by Kessler, et al. and issued on Mar. 11, 1997, is for a solid state dye laser host. It discloses a solid state dye laser incorporating a polyacrylamide gelatin solid host that is doped with a laser dye such as rhodamine 6G and pyrromethene 556.

U.S. Pat. No. 5,237,582 by Moses and issued on Aug. 17, 1993, is for a conductive polymer dye laser and diode and method of use.

U.S. Pat. No. 5,222,092 by Hench, et al. and issued on Jun. 22, 1993, is for laser dye impregnated silica sol-gel monoliths. It discloses a dye laser comprising a highly porous, consolidated silica sol-gel monolith having incorporated therein at least one laser dye, wherein said dye laser is substantially solvent free.

U.S. Pat. No. 5,109,387 by Garden, et al. and issued on Apr. 28, 1992, is for a dye laser system and method. It discloses a dye laser system and method for operation thereof. The dye laser includes a laser cavity capable of lasing in response to an energy source, a circulation path for pumping a dye solution to the laser cavity, and a regeneration medium containing saturated dye solution at equilibrium with the concentration of the dye solution in the circulation path located in the circulation path so that the dye solution is regenerated by circulation through the regeneration medium.

U.S. Pat. No. 4,896,329 by Knaak and issued on Jan. 23, 1990, is for laser dye liquids, laser dye instruments and methods. It discloses laser dye liquids, lasers utilized therewith and methods of formulating the laser dye liquids.

U.S. Pat. No. 4,878,224 by Kuder, et al. and issued on Oct. 31, 1989, is for dye lasers. It discloses a tunable laser device which is characterized by a dye laser medium which consists of a porous glass matrix containing an incorporated solution of a lasing dye, and which is adapted to operate continuously in combination with an optical pumping means.

U.S. Pat. No. 4,397,023 by Newman, et al. and issued on Aug. 2, 1983, is for a high efficiency dye laser. It discloses a long rare-gas halide excimer light source excited by a capacitively coupled discharge that pumps a dye laser with high efficiency in a configuration matched to the length of the discharge.

There is still room for improvement in the art.

### SUMMARY OF INVENTION

The present invention relates to a method and a device for synthesis of solid state dye lasers and in more particular by the use of a y-irradiation polymerization method.

This invention has a Solid state dye laser (SSDL) mixture of rhodamine B (RB) dissolved in ethylene glycol (EG) and added in a 2-hydroxyethyl-methacrylate (HEMA) methyl-methacrylate (MMA) copolymerized by gamma irradiation method (GIM). The resulted optical properties compared with sample copolymerized by conventional method using an Oven.

### BRIEF DESCRIPTION OF DRAWINGS

Without restricting the full scope of this invention, the preferred form of this invention is illustrated in the following drawings:

FIG. 1 shows a schematic view of the solid state dye laser system constructed according to the invention;

FIG. 2 displays the photostabilities of solid state dye lasers samples of RB/EG-P(HEMA-MMA) polymerized by GIPM and CTPM methods, respectively;

FIG. 3 displays the conversion vs. radiation dose of the GIPM sample. The polymerization began at 2 kGy and becomes more viscose with increasing the irradiation dosage. A complete polymerization noticed at 8 kGy;

FIG. 4 displays the intensity spectra differences between GIPM and CTPM samples with length of 15 mm and diameter 12 mm pumped transversely by Nd:YAG laser of 6 mj @ 532 nm, 5 Hz, 10 ns; and

FIG. 5 displays t lasing spectra generated from CTMP and GIPM samples of MMA/HEMA-RB/EG pumped by Nd:YAG laser beam of 6 mJ @ 532 nm with 5 Hz, 10 ns.

### DETAILED DESCRIPTION

The following description is demonstrative in nature and is not intended to limit the scope of the invention or its application of uses.

There are a number of significant design features and improvements incorporated within the invention.

Dye lasers offering both pulsed and continuous-wave operation are considered to be among the most successful laser sources currently in use due to their broad spectral range tuning from ultraviolet to the infrared and high quantum efficiency. They are simpler to produce and are cheap in comparison with other laser sources.

These lasers are used in fundamental physics, spectroscopic techniques, and such diverse areas as applications in industry, medicine, and military.

Two types of dye-doped active laser medium are mainly used, namely liquid and solid-state. At present, research on solid-state dye lasers is a very active field relative to conventional liquid dye laser because it has some operational advantages such as compactness, low cost fabrication techniques, suppression of flow fluctuations, suppression of evaporation of solvent.

The processability, the photo-stability, and thermostability of the solid-state dye laser materials are sought to be improved continuously. Several solid-host materials have been embedded with dyes to obtain laser emission.

High laser-damage resistance dye-doped host materials have been developed such as: modified polymers (modified-PMMA), co-polymers (PMMA/HEMA), sol-gel (tetra-methoxysilane (TMOS), tetraethoxysilane (TEOS)).

In the current invention, solid state dye laser (SSDL) mixture of rhodamine B (RB) dissolved in ethylene glycol (EG) and added in a 2-hydroxyethyl-methacrylate (HEMA) methyl-methacrylate (MMA) copolymerized by gamma irradiation method (GIM). The resulted optical properties are comparable with sample copolymerized by conventional method using Oven.

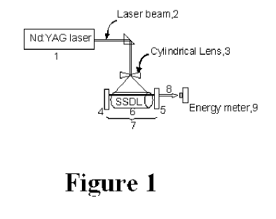

FIG. 1 shows a dye-doped solid state dye laser 7 constructed according to the invention. A dye-doped Polymer sample 6 within an optical cavity 7 is pumped by a pumping laser 1, to achieve laser output 8. The illustrated optical cavity 7 is twenty centimeters in length and includes of a full visible wavelength reflector mirror 4 and 75% reflector mirror 5. A cylindrical lens 3, with a focal length of 15 cm, focuses the pump laser 2 into the solid dye matrix 6.

More particularly, the optical cavity 7 contains a dye doped polymer 6. The dye doped polymer 6 is transversely pumped by the second harmonic of a laser 2. In the illustrated embodiment, the pump laser beam 2 is formed into a mildly focused line using a cylindrical lens 3. Once the laser cavity 7 is aligned, a laser beam at maximum peak of 598 nm is generated 8 from the optical cavity.

The current invention uses the following material fabrication: the monomer is MMA that is distilled to remove the Inhibitor (hydroquinone monomethyl ether) and mixed with HEMA (volume 1:1). Rohdamine B is dissolved into Ethylene Glycol and then added to the mixed MMA/HEMA monomers according to the concentration requirements. The mixture is placed in a water-filled ultrasonic bath in order to mix the dye into the monomer. Air-tight glass tubes containing the dye mixture is placed in cobalt 60 with out adding initiator Azo-bis-isobutyronitrile (ABIN). The dye mixture is exposed to a gamma ray radiation for polymerization under 15° temperature. The complete polymerization occurred at 8 kGy_(after only 1.5 hours). Glass tubes are broken to remove the polymerized samples, which are then cut and optically polished in a form suitable for laser operation. These samples are ready to be pumped to produce laser light with maximum wavelength at 598 nm.

This is very different from the current art where after step 3: which adds Azo-bis-isobutyronitrile (ABIN) polymerization initiator into the mixture, place the mixture once again in the ultrasonic bath to completely dissolve all the additives, use Air-tight glass tubes containing the dye mixture and they place it in an oven at a temperature of 40° c for 5 days in the dark. Afterwards they increase the temperature to 50° c for 3 days and to 70° for one day. They reduce the temperature to room temperature over 6 hours. Then they break the glass tubes to remove the polymerized samples, which are then cut and optically polished in a form suitable for laser operation.

The current invention will be used by companies fabricating solid state dye lasers materials.

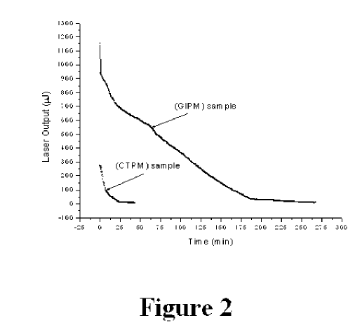

FIG. 2 shows the photostabilities of solid state dye lasers samples of RB/EG-P(HEMA-MMA) polymerized by GIPM and CTPM methods, respectively. The samples with cylindrical shapes of lengths 15 mm and diameters 12 mm. The pump source was Nd:YAG with 5 mJ @532 nm, 5 Hz and 10 ns.

The processability time has been reduced by 99% when GIPM method is used, and no initiator needed. This new method of processability, to the best of our knowledge, is the fastest way in fabricating solid state dye laser samples so far. Polymerization processes started between 6-8 kGy dosages and no sign of polymerization was recognized less than this range.

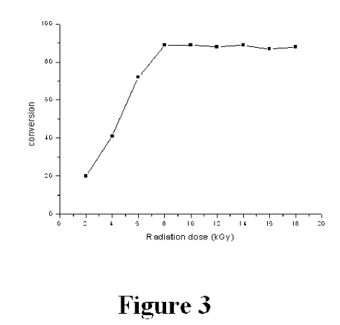

FIG. 3 shows the conversion vs. radiation dose of the GIPM sample. The polymerization began at 2 kGy and becomes more viscose with increasing the irradiation dosage. A complete polymerization noticed at 8 kGy.

The polymerization time was reduced from 8.5 days in the case of conventional thermal polymerization method (CTPM) to less than 2 hours in the case of gamma irradiation polymerization method (GIPM). No initiator was used in the case of GIPM.

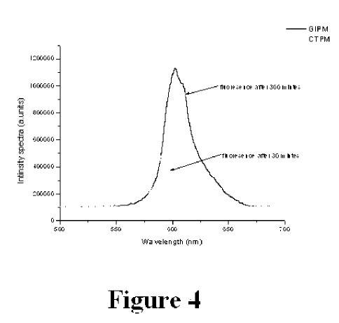

The cross link of the samples was enhanced due to the formation of free radicals by irradiation. Both samples pumped with Nd:YAG of 532 nm having 6 mJ/pulse, 5 Hz, and 10 ns. FIG. 4 shows intensity spectra differences between GIPM and CTPM samples with length of 15 mm and diameter 12 mm.

The fluorescence spectra of the sample copolymerized by GIPM method reveal higher intensity by a double than the sample copolymerized by thermal method. The lasing spectra showing a maximum wavelength of 598 nm for sample copolymerized by TCPM and sample copolymerized by GIPM method, respectively.

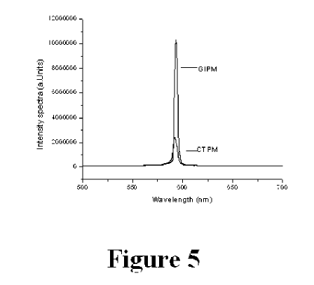

The photostability of the sample copolymerized by GIPM method shows a significant enhancement on the laser action. This is up to three times more than the sample copolymerized by CTPM method using AIBN initiator. FIG. 5 shows the laser beam intensity generated from CTPM and GIPM samples.

All types of polymeric doped dyes materials in solid state dye laser can be fabricated by Gamma ray irradiation polymerization method (GIPM). We are claiming that this laser material synthesis is the first, using “gamma irradiation polymerization method” (GIPM).

Photostabilities of solid state dye lasers samples of RB/EG-P(HEMA-MMA) polymerized by GIPM and CTPM methods, respectively are shown in FIG. 2. The samples with cylindrical shapes of lengths 15 mm and diameters 12 mm. The pump source was Nd:YAG with 5 mJ @532 nm, 5 Hz and 10 ns.

The conversion vs. radiation dose of the GIPM sample is shown in a graph in FIG. 3. The polymerization began at 2 kGy and becomes more viscose with increasing the irradiation dosage. A complete polymerization noticed at 8 kGy.

Intensity spectra differences between GIPM and CTPM samples with length of 15 mm and diameter 12 mm pumped transversely by Nd:YAG laser of 6 mJ @ 532 nm, 5 Hz, 10 ns as shown in FIG. 4.

FIG. 5 displays the lasing spectra generated from CTMP and GIPM samples of MMA/HEMA-RB/EG pumped by Nd:YAG laser beam @ 532 nm with 5 Hz, 10 ns.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A solid state dye laser host, comprising monomers of MMA (methyl-methacrylate) and HEMA (2-hydroxyethyl-methacrylate) (volume 1:1) mixed with rhodamine B dissolved in Ethylene Glycol (EG) copolymerized by a gamma irradiation polymerization method.

2. A solid state laser host according to claim 1, wherein the inhibitor is hydroquinone monomethyl ether.

3. A solid state laser host according to claim 1, wherein said mix is at a one to one ratio.

4. A solid state laser host according to claim 1, wherein the said mix is placed in a water-filled ultrasonic bath to mix the dye into the monomer.

5. A solid state laser host according to claim 1, wherein said mix is placed in air-tight glass tubes which are placed in cobalt 60.

6. A solid state laser host according to claim 2, wherein said mix is exposed to a gamma ray radiation for polymerization under 15° C.

7. A solid state laser host according to claim 6, wherein the complete polymerization occurred at 8 kGy.

8. A solid state laser host according to claim 5, wherein said Glass tubes are broken to remove the polymerized mix, which is then cut and optically polished in a form suitable for laser operation.

9. A solid state dye laser host, comprising monomers of MMA (methyl-methacrylate) and HEMA (2-hydroxyethyl-methacrylate) (volume 1:1) mixed with rhodamine B dissolved in Ethylene Glycol (EG) copolymerized by a gamma irradiation polymerization method, where the said mix is placed in a water-filled ultrasonic bath to mix the dye into the monomer, then said mix is placed in air-tight glass tubes which are placed in cobalt 60 and exposed to a gamma ray radiation for polymerization under 15° C. and then said glass tubes are broken to remove the polymerized mix, which is then cut and optically polished in a form suitable for laser operation.

10. A method to make a solid state dye laser hostcomprising monomers of MMA (methyl-methacrylate) and HEMA (2-hydroxyethyl-methacrylate) (volume 1:1) mixed with rhodamine B dissolved in Ethylene Glycol (EG) copolymerized by a gamma irradiation polymerization method.

11. A method to make a solid state laser host according to claim 10, adds the step of copolymerizing said mix by a gamma irradiation method.

12. A method to make a solid state laser host according to claim 11, wherein said inhibitor is hydroquinone monomethyl ether.

13. A method to make a solid state laser host according to claim 11, wherein said mix of MMA and HEMA are at a one to one ratio.

14. A method to make a solid state laser host according to claim 11, further comprising placing said mix in a water-filled ultrasonic bath to mix the dye into the monomers.

15. A method to make a solid state laser host according to claim 11, further comprising placing said mix in air-tight glass tubes which are placed in cobalt 60.

16. A method to make a solid state laser host according to claim 11, further comprising exposing said to a gamma ray radiation for polymerization under 15° C.

17. A method to make a solid state laser host according to claim 11, further comprising having the complete polymerization occurred at 8 kGy.

18. A method to make a solid state laser host according to claim 16, further comprising breaking said Glass tubes to remove the polymerized mix, which is then cut and optically polished in a form suitable for laser operation.
